(19) United States
(12) Patent Application Publication
(10) Pub. No.: US 2018/0253391 A1
(43) Pub. Date: Sep. 6, 2018

(54) MULTIPLE CHANNEL MEMORY CONTROLLER USING VIRTUAL CHANNEL

(71) Applicant: Foundation of Soongsil University-Industry Cooperation, Seoul (KR)

(72) Inventor: Chan Ho LEE, Seoul (KR)

(73) Assignee: Foundation of Soongsil University-Industry Coorperation, Seoul (KR)

(21) Appl. No.: 15/912,587

(22) Filed: Mar. 6, 2018

(30) Foreign Application Priority Data
Mar. 6, 2017 (KR) 10-2017-0028268

(51) Int. Cl. G06F 13/16; G06F 3/06

(52) U.S. Cl. CPC G06F 13/1668; G06F 3/0679; G06F 3/0662; G06F 3/0613

(57) ABSTRACT

A multiple channel memory controller includes: an application adaptor that transfers a command or data received from a host to the outside, and transfers a response associated with the transferred command or data to the host; a plurality of memory adaptors that are respectively connected one-to-one to a plurality of memory devices to form corresponding physical channels; and a virtual channel controller that is located between the application adaptor and the plurality of memory adaptors, and transfers the command or data to at least one physical channel allocated to the virtual channel.

### CROSS-REFERENCE TO RELATED APPLICATION

This application claims priority to and the benefit of Korean Patent Application No. 10-2017-0028268 filed in the Korean Intellectual Property Office on Mar. 6, 2017, the entire contents of which are incorporated herein by reference.

### BACKGROUND OF THE INVENTION

### (a) Field of the Invention

The present invention relates to a multiple channel memory controller using a virtual channel. More particularly, the present invention relates to a multiple channel memory controller using at least one virtual channel that may effectively process access of multiple processes.

### (b) Description of the Related Art

An embedded multimedia card (eMMC), which is a next-generation memory to replace an SD card widely used as an external memory device, is a non-volatile memory that NAND flash memories and a multimedia card (MMC) controller are integrated. A data width of the SD card widely used as a currently external non-volatile memory is 4 bits, while a data width of the eMMC is 8 bits, which is twice of that of the SD card, and the eMMC is capable of high-speed operation and has a transfer speed about 8 times faster than the SD card, thus it is expected to quickly replace the SD card. In addition, its package type is changed from a card type to a general semiconductor package type, thus it may be manufactured to be mounted on a PCB board or to be suitable for a separate high-speed interface.

On the other hand, recently, in accordance with development of a multiple processor systems and a demand for a high-speed, large-capacity non-volatile memory, an external memory device corresponding thereto is required.

The conventional SD card, due to its package characteristic and limited performance, may not simultaneously but sequentially process multiple demands requested by the multiple processors, thus when the conventional SD card processes the multiple demands, performance thereof greatly deteriorates. In order to satisfy bandwidth enhancement and multiple request access, a memory controller should be designed in a multiple channel structure. When the memory controller includes one channel and the one channel is connected to multiple eMMC devices, its bandwidth enhances, but it is difficult to effectively process multiple access requests. In contrast, when the memory controller has multiple channels and each channel is respectively connected to one eMMC device, it may effectively process the multiple access requests, but its bandwidth enhancement is difficult to expect.

The background of the present invention is disclosed in Korean Patent Laid-Open Publication No. 10-2016-0150552 (published on Dec. 30, 2016).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a multiple channel memory controller using at least one virtual channel that may enhance a bandwidth and process memory access requests of multiple processors.

An exemplary embodiment of the present invention provides a multiple channel memory controller, including: an application adaptor that communicates with a host, transfers a command or data received from the host to the outside, and sends a response associated with the transferred command or data to the host; a plurality of memory adaptors that are respectively connected one-to-one to a plurality of memory devices to form respective physical channels; and a virtual channel controller that is located between the application adaptor and the plurality of memory adaptors, generates at least one independent virtual channel to which at least one of a plurality of physical channels is allocated, and transfers the command or data to at least one physical channel allocated to the virtual channel, wherein the virtual channel controller may dynamically adjust the number of virtual channels or the number of physical channels allocated to the virtual channel, based on a transfer condition of the data or the number of access processors requested by the host.

The virtual channel controller may include a table which configures the virtual channel, a new virtual channel may be added when it is created, and then an existing virtual channel may be deleted when it is not necessary. A virtual channel may be activated when a request is assigned, and operate independently until an operation corresponding to the request is completed. The virtual channel is de-activated when the operation using the virtual channel is completed.

The virtual channel controller, when there is an access request of a single processor, may generate a single virtual channel, and may transfer the data to the corresponding physical channel through the generated virtual channel, and N (N is an integer of one or more) physical channels may be allocated to the single virtual channel according to a transfer condition of the requested data of the single processor.

When the transfer condition satisfies a predetermined condition, N sub-data obtained by dividing the data into N (W≥2) blocks may be simultaneously transferred to corresponding N physical channels to drive a bandwidth-enhancement mode, and when the transfer condition does not satisfy the predetermined condition, one physical channel may be allocated to the single virtual channel, such that the data may be transferred to the allocated one physical channel.

The virtual channel controller may configure the virtual channel based on the transfer condition or the number of the access processors determined by the host, and may analyze a request of the host inputted thereto to change the virtual channel dynamically or set in a fixed manner, and the host may request a configuration to dynamically change the virtual channel in consideration of a current system status.

The virtual channel controller, when there are access requests of multiple processors including a plurality of processors, may independently generate one virtual channel per each processor, and may drive a multiple process mode of simultaneously processing the requests of multiple processors through the generated virtual channels, respectively.

The multiple processor may include at least one first processor in which the transfer condition of the data satisfies the predetermined condition and at least one second processor in which the transfer condition of the data does not satisfy the predetermined condition, and the virtual channel controller may allocate N (N≥2) physical channels to a virtual channel generated corresponding to the first processor, and may allocate one physical channel to a virtual channel generated corresponding to the second processor to simultaneously drive the bandwidth-enhancement mode and the multiple process mode.

According to the multiple channel memory controller using the virtual channel of the embodiment of the present invention, it is possible to adaptively control the number of physical channels allocated to the virtual channel and generation of the virtual channel corresponding to a data transfer amount and the number of processor accesses, thereby supporting both bandwidth enhancement and multiple processes and effectively responding to each of accessed multiple processors.

### BRIEF DESCRIPTION OF THE DRAWINGS

FIG. 1 illustrates a schematic view of a multiple channel memory controller according to an exemplary embodiment of the present invention.

FIG. 2 illustrates a structure of the APB interface shown in FIG. 1.

FIG. 3 illustrates a structure of the AXI interface shown in FIG. 1.

FIG. 4 illustrates a graph of comparing data transfer cycle numbers depending on positions of DMACs in an exemplary embodiment of the present invention.

FIG. 5 and FIG. 6 respectively illustrate a structure of a command controller and a structure of a data controller included in the memory adaptor shown in FIG. 1.

FIG. 7 illustrates a structure of the virtual channel controller shown in

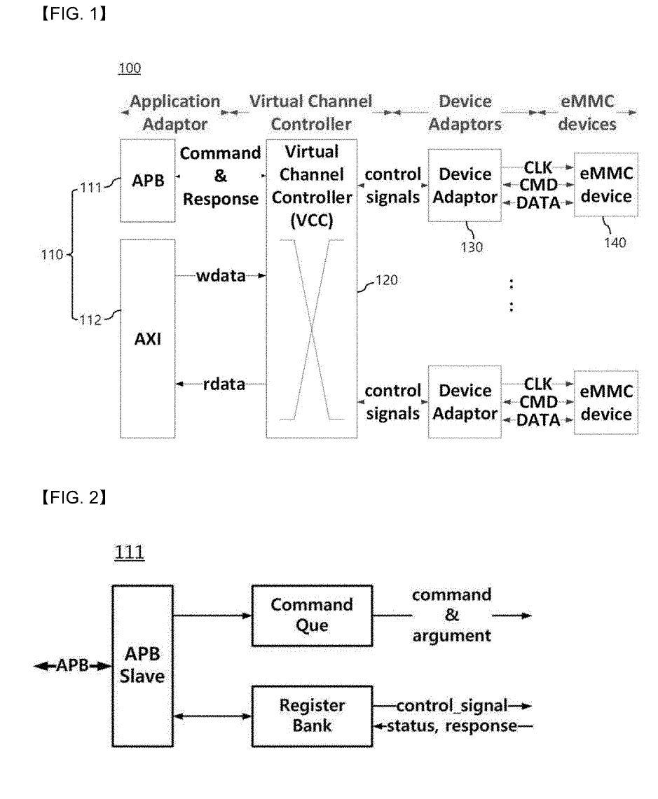

FIG. 1.

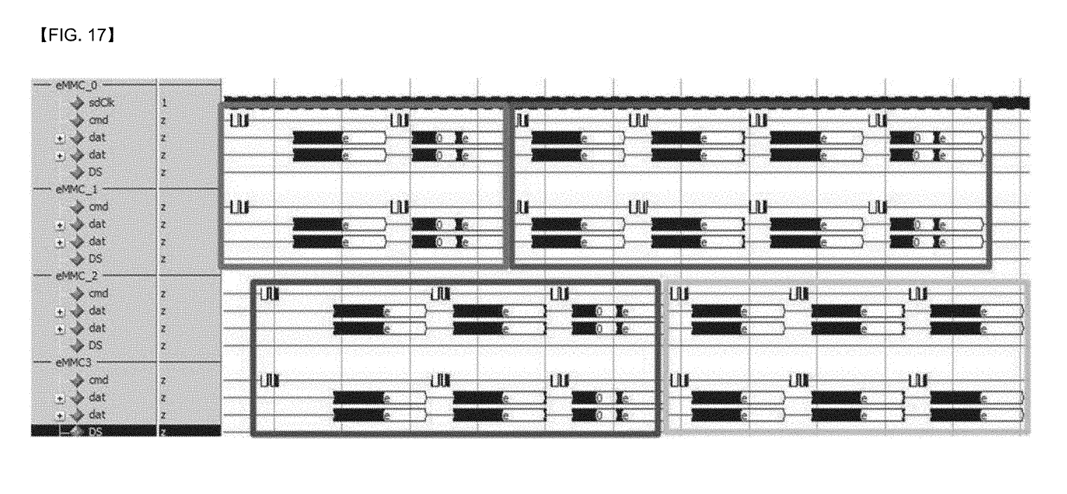

FIG. 8 illustrates a process of a reading or writing operation using the virtual channel controller of FIG. 7.

FIG. 9 illustrates processing operations of multiple processors using a virtual channel controller according to an exemplary embodiment of the present invention.

FIG. 10 illustrates a simulation structure for verification of a multiple channel memory controller according to an exemplary embodiment of the present invention.

FIG. 11 illustrates a waveform diagram when four eMMC devices are allocated to one virtual channel by a host and operate.

FIG. 12 and FIG. 13 illustrate diagrams for comparing operations of a controller according to an embodiment of the present invention and a conventional controller in multiple read requests.

FIG. 14 and FIG. 15 respectively illustrate a difference between an operation of a conventional controller in which all four channels are combined and operated and an operation of a controller according to an embodiment of the present invention that operates using virtual channels, when data is transferred.

FIG. 16 and FIG. 17 illustrate performance comparison results when amounts of transfer data are different depending on processors.

### DETAILED DESCRIPTION OF THE EMBODIMENTS

The present invention will be described more fully hereinafter with reference to the accompanying drawings, in which exemplary embodiments of the invention are shown.

The present invention relates to a multiple channel memory controller using a virtual channel, which proposes a multiple channel memory structure capable of both bandwidth enhancement and multiple access requests. In exemplary embodiments of the present invention, a memory is generally exemplified by describing an embedded multimedia card (eMMC) which is a next generation memory.

FIG. 1 illustrates a schematic view of a multiple channel memory controller according to an exemplary embodiment of the present invention. Referring to FIG. 1, a multiple channel memory controller (multiple channel eMMC controller) 100 according to an exemplary embodiment of the present invention includes an application adaptor 110, a virtual channel controller (VCC) 120, a plurality of memory adaptors (device adaptors) 130, and a plurality of memory devices (eMMC devices) 140.

The application adaptor 110 communicates with a host (not shown), transfers a command or data received from the host to the virtual channel controller 120, receives a response and data associated with the command or data through the virtual channel controller 120, and transfers them to the host so that the host reads the response or data. The host includes at least one processor and main memory (usually DRAM).

The command and data substantially transferred by the application adaptor 110 to the memory device (eMMC device) 140 passes through the virtual channel controller 120 and the memory adaptor 130 in order, and the response and data are also returned via an opposite path.

The application adaptor 110 includes two interfaces, that is, an AMBA APB slave interface 111 (hereinafter referred to as an APB interface) and an ABMA AXI master interface 112 (hereinafter referred to as an AXI interface).

The advanced peripheral bus (APB) interface 111 transfers a command to the virtual channel controller 120, and receives a response of the memory device 140 through the virtual channel controller 120 to provide it to the host. The advanced extensible Interface (AXI) interface 112 transfers data from the memory device to the host or from the host to the memory device, respectively, through the virtual channel controller 120. Each structure of the interfaces will be described in detail later.

The plurality of memory adaptors 130 are connected to the plurality of memory devices 140 in a one-to-one manner to form respective physical channels. One memory adaptor 130 and one memory device 140 are connected to each other to form one physical channel. Accordingly, the number of the physical channels is identical to that of the memory adaptors 130 or the memory devices 10.

The virtual channel controller 120 is located between the application adaptor 110 and the plurality of memory adaptors 130. Specifically, the virtual channel controller 120 generates at least one independent virtual channel (VC) to which at least one of the plurality of physical channels is allocated, and transfers a command or data to at least one physical channel allocated to the virtual channel. When one or more physical channels are allocated to one virtual channel, data is transferred to one or more allocated physical channels.

The memory adaptor 130 may transfer the command or data received from the virtual channel controller 120 to the memory device 140, and then may receive the response or data from the memory device 140 to transfer the received response or data to the virtual channel controller 120. The memory adaptor 130 may serve to temporarily store data.

In the exemplary embodiment of the present invention, the virtual channel controller 120 may dynamically adjust the number of virtual channels or the number of physical channels to be allocated to each virtual channel, based on a data transfer condition or the number of access processors in the host. Before specifically describing this, each constituent element of the multi-channel memory controller 100 will be described in more detail as follows.

First, the application adaptor 110 serves to communicate with the host system, and uses the same interface protocol as an on-chip network of a host system. As described above, the application adaptor 110 includes the APB interface 111 for transferring a command and for reading a status and a response of the eMMC, and the AXI interface 112 for transferring data.

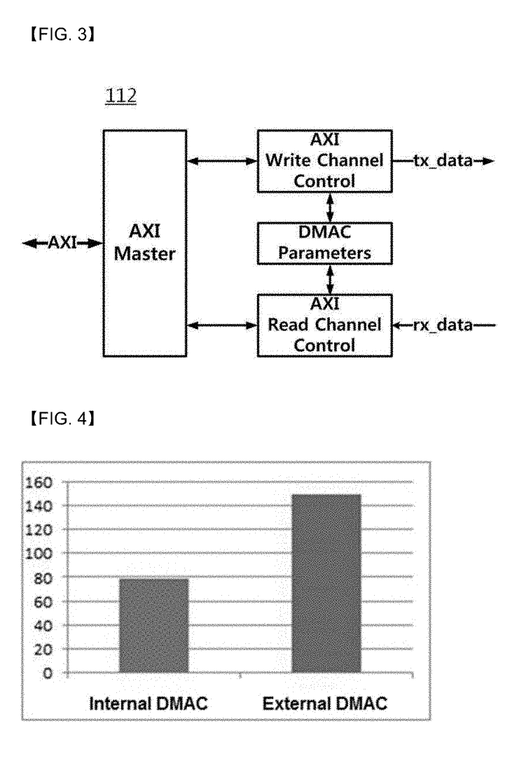

FIG. 2 illustrates a structure of the APB interface shown in FIG. 1. The APB interface 111 is an AMBA APB-based slave interface, which is used to configure parameters required for transferring data, to send a command for the eMMC controller, and to read a response of the eMMC devices corresponding to the command. The APB interface 111 stores commands and arguments in a queue, and when the eMMC controller 100 receives a response after transferring a command, a next command transfer is possible without a delay time.

Specifically, the APB interface 111 includes a command queue and a register bank. The command queue stores the commands and the arguments and transfers them to the virtual channel controller 120.

The register bank stores parameters for configuring operations of the controller 100 such as a size of a block, the number of the blocks, addresses to which a direct memory access controller (DMAC) of an AXI master interface accesses, a mode selection signal, a time-out signal, etc. in the memory device 140. In addition, it stores the response signals of the memory device 140 such that the host may read it when necessary.

FIG. 3 illustrates a structure of the AXI interface shown in FIG. 1. The AXI interface 112 is an AMBA AXI-based master interface, which is used for data transfer and serves to perform data transfer between the eMMC and the storage device of the host. The AXI interface 112 includes a DMAC, and when the host requests data transfer through the APB interface 111, directly writes data to a predetermined address for reading the request of the host or directly reads data from the predetermined address for writing the request of the host.

Specifically, since the AXI interface 112 has a separate write channel control and a read channel control using characteristics of the AXI, it is possible to simultaneously read and write data in the host. Accordingly, the best performance thereof may be achieved by properly arranging read and write requests in the host.

A reason why the DMAC is used in the AXI interface 112 is to enhance data transfer efficiency by reducing an on-chip network usage amount compared to a case in which the DMAC is disposed at the outside or the host processor transfers data. That is, when data is transferred through a host processor or an external DMAC, the data is read through the on-chip network by the host processor or the external DMAC and then, written to a destination through the on-chip network by the host processor or the external DMAC all the time, but when the data is directly written to the destination by the internal DMAC in the AXI interface 112, data transfer is completed through one data network access. Since an internal DMAC operates according to the parameters configured through the APB interface 111, it may be controlled by the host.

FIG. 4 illustrates a graph of comparing data transfer cycle numbers depending on positions of DMACs in an exemplary embodiment of the present invention. FIG. 4 is a graph comparing results of executing the DMAC at the inside and the outside, respectively, when data of 512 bytes, which is a minimum unit of reading and writing operations of the eMMC, is transferred. It can be seen that the eMMC controller that transfers the data using the internal DMAC decreases the cycle number to 55% compared with that using the external DMAC. Next, a configuration of an eMMC adapter, that is, the memory adapter 130 will be described. The memory adaptor 130 serves as a controller for reading and writing data in the memory device 140.

The memory adaptor 130 includes a command controller and a data controller. The command controller serves to transfer a command inputted through the APB interface 111 to the memory device 140 at an appropriate timing and to receive a response. The data controller serves to transfer data between the AXI interface 112 and the memory device 140. In this case, the command may be a command directly controlling the eMMC or a memory access command promised between the host processor and the controller. In the former case, the command is represented as the eMMC command hereafter.

In the latter case, the memory access command is converted into at least one eMMC command in a command controller or virtual channel controller. A command may be either the eMMC command or the memory access command.

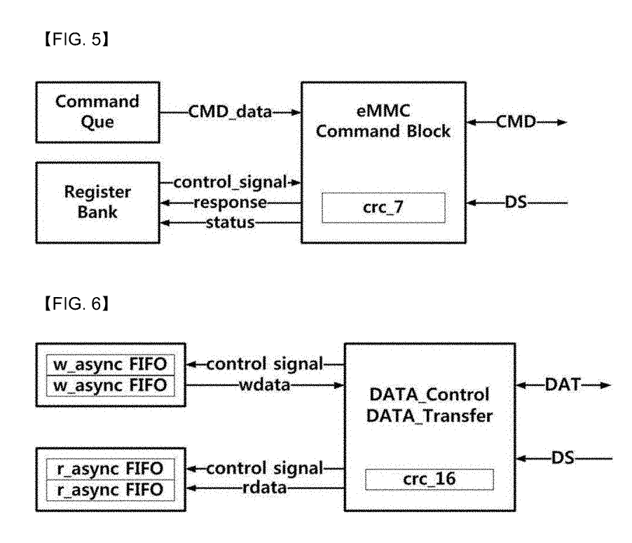

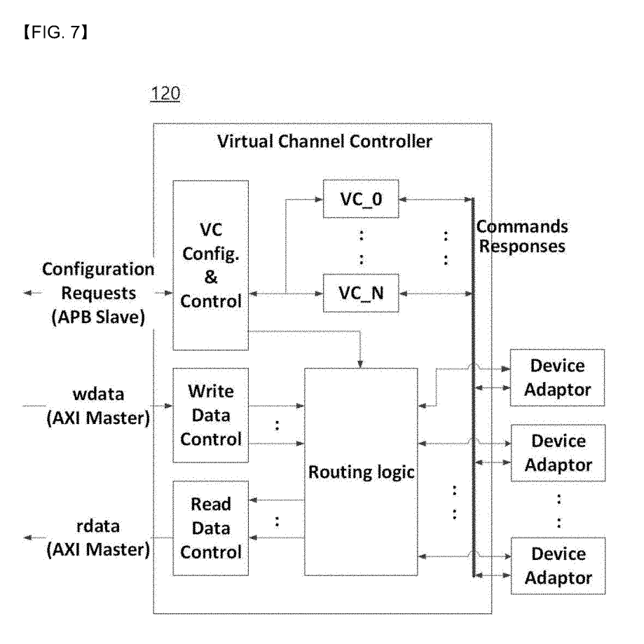

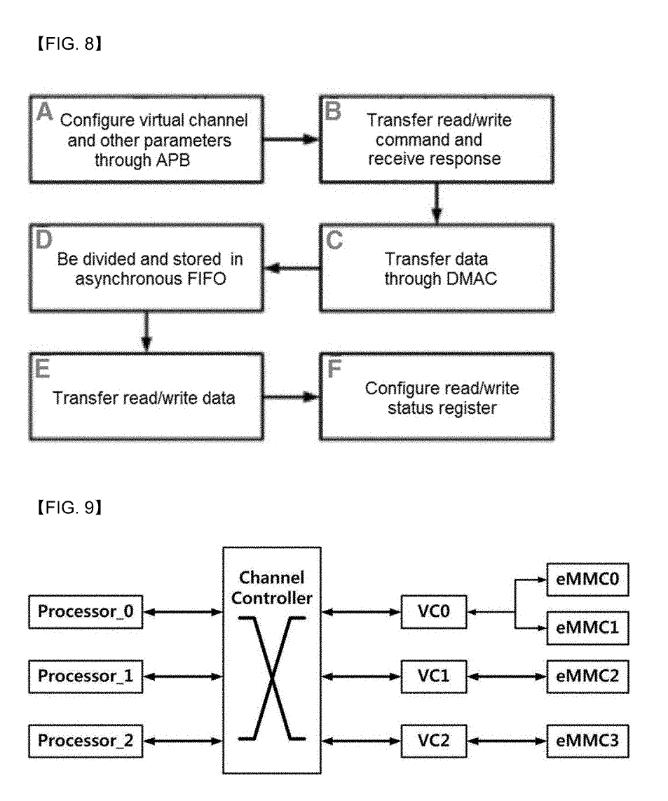

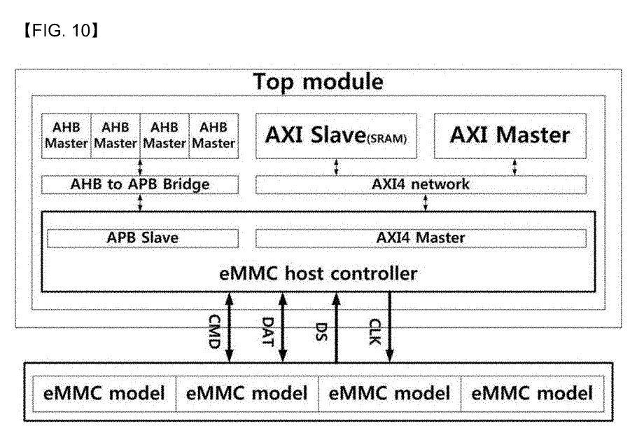

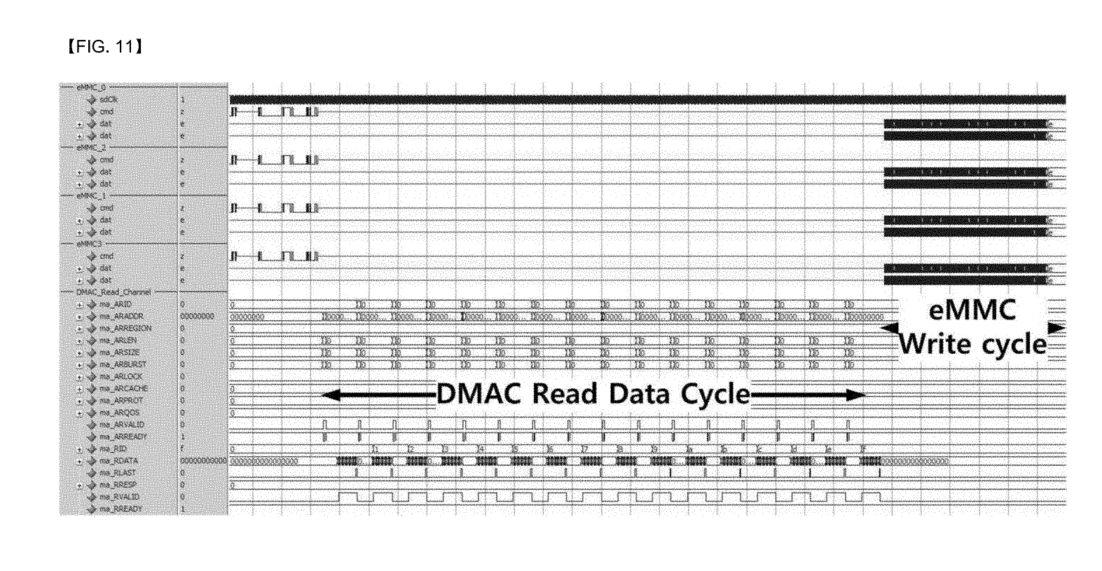

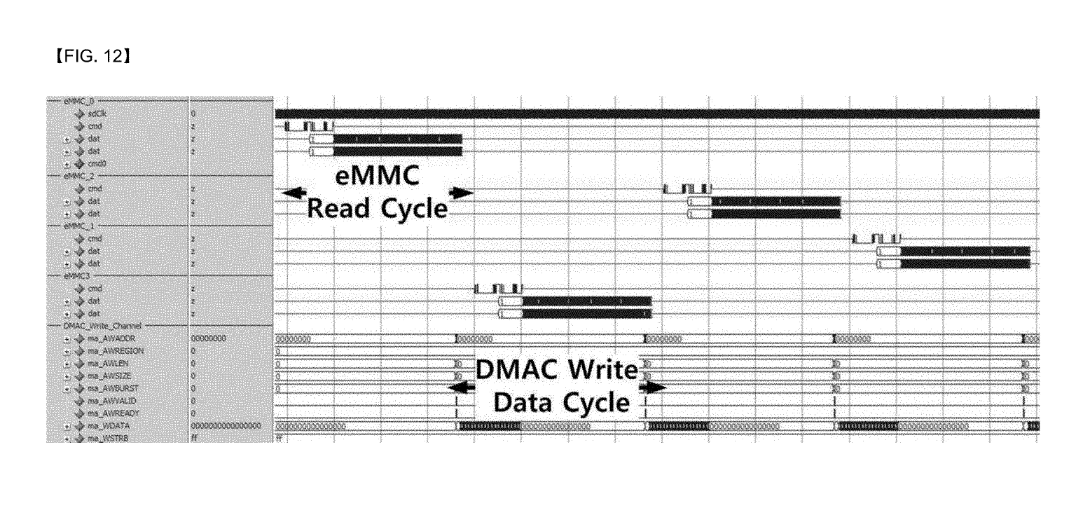

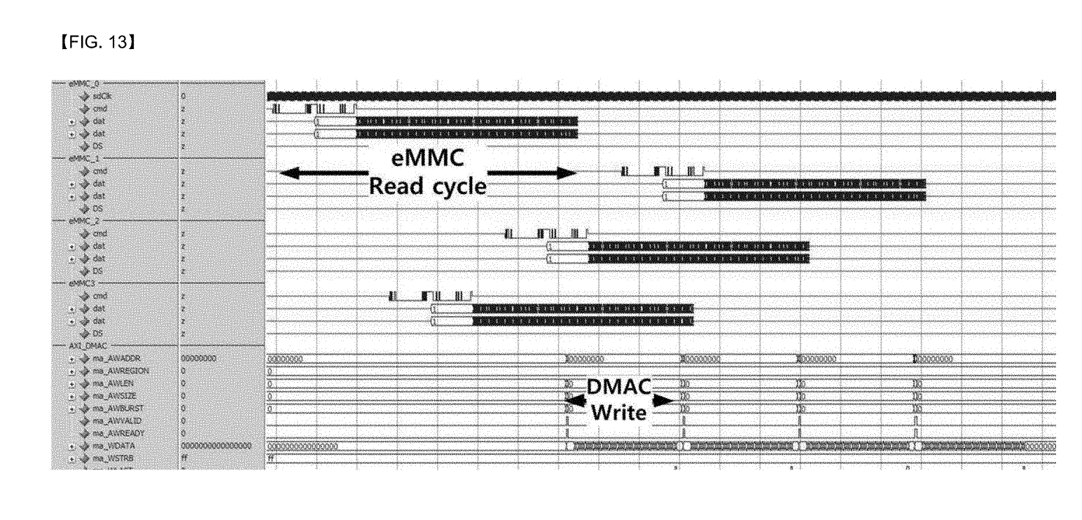

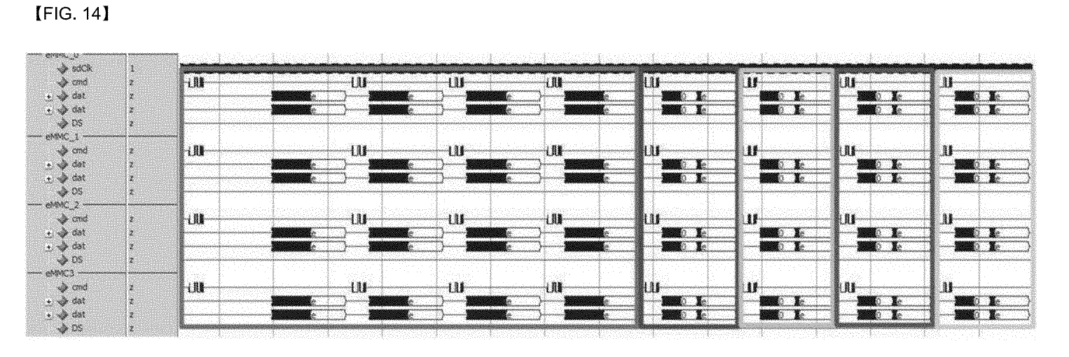

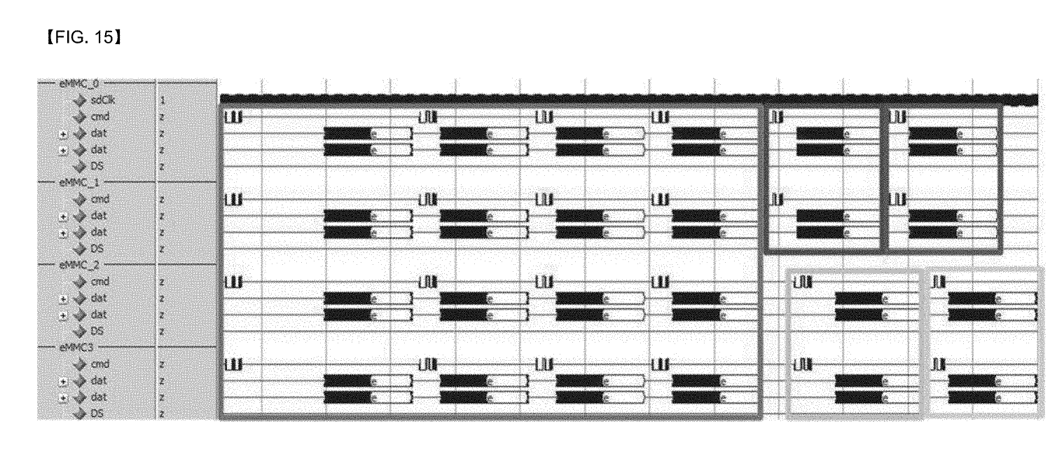

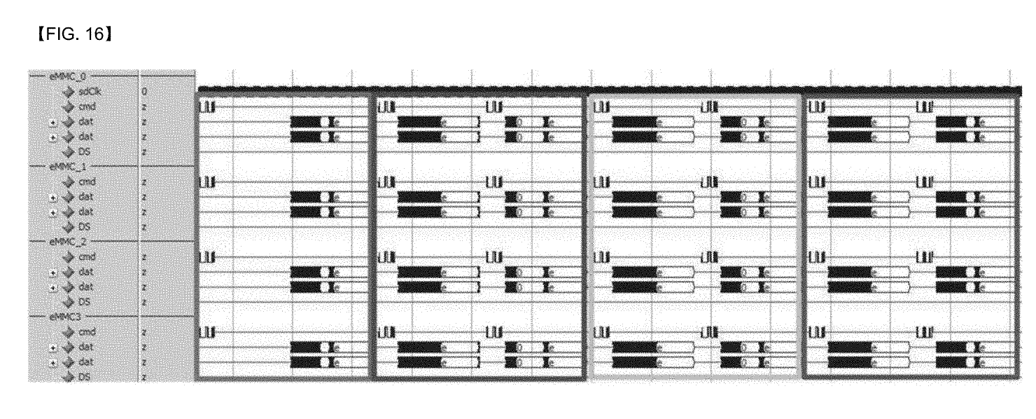

FIG. 5 and FIG. 6 respectively illustrate a structure of a command controller and a structure of a data controller included in the memory adaptor shown in FIG. 1.

First, referring to FIG. 5, the command controller consists of a command control block and a command transfer block (eMMC command block). The command control block, which is at a left side, includes a command queue for transferring a command and a register bank of status registers that is updated according to the response of eMMC devices and represents results of an operation by the command. After the configuration of the status registers is completed, the host can read the status register via the APB.

The eMMC command block transfers the configured command to the eMMC device through a command line (CMD line) by 1 bit per one cycle, and after the command is transferred, the eMMC command block receives responses through the CMD line, and then bundles them in 32-bit units so that the host may read them through the APB. All commands and responses are checked through cyclic redundancy codes 7 (CRC7) module for detecting errors during transferring.

Next, referring to FIG. 6, the data controller consists of a data control block (DATA Control) and a data transfer block (DATA_Transfer). In the data control block, by analyzing an eMMC response signal to determine whether data is successfully read or written, the data status registers in the register bank are configured.

The data transfer block connects the eMMC device and a buffer of the DMAC to transfer data to the eMMC device or read data from the eMMC device in a manner defined by parameters configured through the APB. In addition, the data transfer block may generates control signals of the asynchronous first input first output (FIFO), and may read data from eMMC devices or write data to eMMC devices in predetermined ways by a mode configuration such as a single data rate (SDR), a double data rate (DDR), HS200, and HS400. The read and write asynchronous FIFO uses a double buffering method, and it is possible to communicate between the eMMC device and the host without interrupting data transfer in a plurality of blocks. All read and write data are checked through the CRC16 module for detecting errors during transferring.

The virtual channel controller 120 may simultaneously process a plurality of data transfer requests from the host when a plurality of eMMC devices are connected. That is, when data read or write requests are inputted to different devices, the requests are simultaneously processed, thereby increasing performance of the system. For this, the plurality of memory adaptors 130 control the memory devices 140 allocated thereto, and the virtual channel controller 120 integrally manages the respective memory adaptors 130.

The virtual channel controller 120 is a core block that enables a plurality of channel data transfers in response to requests from the multiple processors. The virtual channel controller 120 generates a virtual channel by the host or an internal policy, and the virtual channel includes one or more physical channels. The physical channel consists of the memory adaptor 130 and the memory device 140. The virtual channel is generated by a combination of one or more physical channels and generates signals for controlling an operation of each physical channel.

Herein, when one virtual channel is generated by grouping all the plurality of physical channels, a bandwidth is enhanced by the number of the physical channels. In contrast, when one physical channel is allocated to one virtual channel, the bandwidth of each channel is not enhanced, but it is possible for each channel to independently operate, thereby maximizing the processing capability for the multiple requests and enhancing the overall bandwidth of a system.

Specifically, the virtual channel controller 120 generates a single virtual channel when a single processor requests access thereto, and transfers data to a corresponding physical channel using the generated virtual channel.

In this case, N (N is an integer of one or more) physical channels are allocated to the single virtual channel according to a data transfer condition of the single processor.

Specifically, when the transfer condition satisfies a predetermined condition, data are divided into N sub-data obtained by dividing the data into N blocks (N≥2) are simultaneously transferred through corresponding N physical channels to drive a bandwidth-enhancement mode. Accordingly, N (N≥2) memory devices 140 corresponding to N (N≥2) physical channels operate as one memory device that has a bandwidth increased by N times the data bandwidth of a single physical channel.

Alternatively, when the transfer condition of the data of the single processor does not satisfy the predetermined condition, only one physical channel may be allocated to the single virtual channel, such that the data is transferred to the allocated one physical channel. For example, when data to be transferred is formed as one block, a virtual channel to which one physical channel is allocated is used, and when data is formed as two or more blocks (N blocks) (e.g., when an amount of data to be transferred exceeds a threshold value (one block)), a virtual channel to which N physical channels corresponding thereto are allocated may be used.

As such, the virtual channel controller 120 may effectively perform the processing of the single processor according to the above-described method, and particularly, when the data transfer condition satisfies the predetermined condition, after the data to be transferred are divided into a plurality of sub-data, the divided data may be simultaneously transferred using the virtual channels to which the corresponding number of physical channels are allocated, thereby enhancing the bandwidth.

In addition, the virtual channel controller 120, when there are access requests of a plurality of processors, i.e., the multiple processors, independently generates one virtual channel for each processor, and it may drive a multiple process mode of simultaneously processing the multiple requests through the generated virtual channels, respectively.

In this case, by considering the data transfer condition of each processor, only the multiple-process mode may be independently driven, or the multiple-process mode and the bandwidth-enhancement mode may be simultaneously driven.

If all of the data transfer conditions for the plurality of processors do not satisfy the predetermined condition, one virtual channel is used for each processor, and in this case, only one physical channel is respectively allocated and driven to each virtual channel, thus, as such a method, respective processors may simultaneously operate in the multiple-process mode.

In the multiple-process mode, separate memories that are simultaneously accessible corresponding to each processor may be used.

In addition, when the data transfer condition for at least one of the plurality of processors satisfies the predetermined condition, the multiple-process mode and the bandwidth-enhancement mode may be simultaneously driven.

As a specific example, a case of the multiple processors including at least one first processor in which the transfer condition of the data satisfies the predetermined condition and at least one second processor in which the transfer condition of the data does not satisfy the predetermined condition will be described as follows.

In this case, the virtual channel controller 120 allocates M (M is an integer of two or more) physical channels to the virtual channel generated corresponding to the first processor, and allocates one physical channel to the virtual channel generated corresponding to the second processor. Through this scheme, the multiple-process mode in which a plurality of processors simultaneously operate is driven, and the bandwidth-enhancement mode for the first processor is driven.

As a result, it is possible to effectively drive the multiple processors by simultaneously performing the bandwidth-enhancement mode and the multiple-process mode, and it is possible to maximize the efficiency of the system by enhancing the overall bandwidth of the system. Another example of this method will be described later in FIG. 9.

In this embodiment of the present invention, the virtual channel controller may configure a virtual channel based on the transfer condition or the number of the access processors. The configuration may be determined by the host or the virtual channel controller 120. That is, the predetermined condition and the virtual channel configuration method are determined by the software executed on the processor of the host or the controller or by the hardware of the controller.

When the host determines the condition and method, the software of the host requests to dynamically change the virtual channel in consideration of a situation of the current system. When the condition and method is determined in the virtual channel controller, the virtual channel is dynamically changed by analyzing the request of the host inputted to the controller or determined in a fixed manner.

FIG. 7 illustrates a structure of the virtual channel controller shown in FIG. 1. The virtual channel controller includes a virtual channel configuration block in communication with the APB interface and a data channel block in communication with the AXI interface.

First, the virtual channel configuration block will be described. The host configures the virtual channel according to the appropriate virtual channel structure and communication method determined in consideration of the system performance through the APB interface. When the virtual channel configuration block receives a memory access command with a logical address, it allocates the corresponding at least one physical address and virtual channel, sends one or a plurality of eMMC device commands for the corresponding memory access command to the virtual channel to be used by the host, reads the responses, and analyzes the results of the memory access operation.

The logical address is used by the host and it is converted to corresponding at least one physical address used by the virtual channel controller. The logical address and the physical address may be the same or different. When the virtual channel configuration block receives an eMMC command, it sends the eMMC command directly to at least one physical channel corresponding to the virtual channel and reads the response.

The virtual channel configuration may be changed dynamically to improve the system performance. The virtual channel configuration and control block in virtual channel controller 120 includes a table which configures virtual channels. A new virtual channel is added when it is created, and an existing virtual channel may be deleted when it is not necessary. A virtual channel is activated when a request is assigned to it. Once a virtual channel is configured and a request is assigned, the virtual channel operates independently until an operation corresponding to the request is completed. A virtual channel is de-activated when the operation using the virtual channel is accomplished.

The virtual channel controller supervises a memory device by sending commands and receiving responses of the memory devices. The virtual channel controller monitors the operations of virtual channels, and controls data flow using a routing logic which makes the physical channel between the AXI master interface and the memory device.

The commands are stored in the command queue allocated to the virtual channel, and respective virtual channels (VC_O, . . . , VC_N) independently operate. The configuration of the virtual channel can be dynamically changed as needed by the host, and the logical command controllers corresponding to the number of the virtual channels are generated and the appropriate commands are transferred to the eMMC adapters (memory adapters).

Next, the data channel block will be described. The number of the data channels connected to the application adaptor is determined by the number of the AXI master interfaces, and there are read channels and write channels as many as the number of the AXI master interfaces, respectively. Generally, since the bandwidth of the AXI interface is much larger than that of the eMMC device (memory device), even if there is a single AXI interface, data of the multiple eMMC devices may be transferred seamlessly. However, when latency (that is, a response time) is important, not the bandwidth, the multiple interfaces are needed to process the multiple processor requests with the less response times.

FIG. 8 illustrates a process of a read or write operation using the virtual channel controller of FIG. 7. In an operation of the virtual channel controller shown in FIG. 8, a difference from a fixed channel controller is the configuration of virtual channels to connect respective virtual channels and eMMC devices (memory devices) to activate them before an access request to the eMMC devices (A).

When a plurality of memory devices 140 are connected to one virtual channel, the bandwidth thereof enhances as much as the number of memory devices 140, and the plurality of memory devices 140 operate as one memory.

In this bandwidth enhancement operation, the virtual channel controller simultaneously transmits the same read or write command to all the memory devices 140 and receives responses therefrom (B).

In the case of the write operation in the bandwidth-enhancement mode, data (C) inputted from the DMAC is divided and stored in a plurality of asynchronous FIFOs corresponding to the respective memory devices 140 configured in the virtual channel (D), and then the divided data (sub data) is transferred to each memory device 140 (E). In the case of the read operation, the sub-data read from each memory device 140 is stored into the corresponding asynchronous FIFOs, and then the sub-data is transferred to the host through the DMAC after the sub-data is combined. In this process, after analyzing the data response of the memory device 140, the operation is completed by updating a status and response register (F).

In contrast, in a multiple-processor system, when each processor independently requests access to the memory devices, each channel must independently operate. This provides an effect of using a separate memory that is accessible at the same time. Accordingly, while one processor is accessing one virtual channel, it is possible for another processor to simultaneously access another virtual channel to transfer data. This means that one controller 100 may simultaneously process a plurality of memory access requests by a plurality of processors.

FIG. 9 illustrates processing operations of multiple processors using a virtual channel controller according to an exemplary embodiment of the present invention. FIG. 9 illustrates accesses of multiple processors including processors 0, 1, and 2, wherein one virtual channel is used for each processor.

Herein, the processor 0 (Processor_0) uses a virtual channel 0 (VC0) to which two eMMC devices (eMMC0 and eMMC1) are allocated. The processor 1 (Processor_1) uses a virtual channel (VC1) to which one eMMC device (eMMC 2) is allocated, and the processor 2 (Processor_2) uses a virtual channel (VC2) to which one eMMC device (eMMC3) is allocated.

That is, when a virtual channel consisting of a plurality of physical channels is allocated in a case that a large amount of data is transferred, and when a virtual channel consisting of one physical channel is allocated in a case that a relatively small amount of data is transferred, a plurality of processors may access the corresponding eMMC memory devices at the same time and a necessary bandwidth and a response time may be ensured, thereby improving system performance. The virtual channel configuration and the bandwidth allocation may be dynamically performed as necessary, thus they may be optimized according to characteristics of the system.

As described above, in the embodiment of the present invention, the virtual channel having one or a plurality of physical channels may be configured, created, allocated, activated, deactivated, deleted, and so on individually using the virtual channel controller, and the accesses of the multiple processors may be effectively processed. Hereinafter, a structure of a multiple channel memory controller according to an exemplary embodiment of the present invention that is designed using Verilog-HDL and is implemented and verified using an FPGA will be described. The multiple channel memory controller was simulated using an eMMC simulation model and ModelSim.

FIG. 10 illustrates a simulation structure for verification of a multiple channel memory controller according to an exemplary embodiment of the present invention.

A plurality of AHB masters serve as multiple processors and an AXI slave serves as a SRAM that temporarily stores data. The AHB masters are connected to the APB interface of the controller through an APB bridge to request and to configure data transfer and to read a response signal. An AXI master of the host serves to write data to the AXI slave to initialize it. An AXI master of the controller reads data of the AXI slave according to instructions of the AHB master using an AXI4 network to write it to the eMMC device, and reads data of the eMMC device to write it to the AXI slave.

FIG. 11 illustrates a waveform diagram when four eMMC devices are allocated to one virtual channel and a host uses the virtual channel. The eMMC devices are set to operate in an HS400 mode and an 8 bit data width condition. FIG. 11 illustrates an operation of reading data of 2 KB from the AXI slave to the eMMC controller using the DMAC of the AXI master and writing the data to the eMMC devices, and in this case, data of one block (512B) is transferred to each of four eMMC devices to complete the writing operation. It can be seen that that since four eMMC devices (four physical channels) are allocated and used to one virtual channel, when 4 blocks are transferred, the transfer speed is four time faster (four times speed) than when one physical channel is used.

FIG. 12 and FIG. 13 illustrate diagrams for comparing operations of a controller according to an embodiment of the present invention and a conventional controller in multiple read requests. The conventional controller has one logical channel that four memory devices are tied together. FIG. 12 illustrates a reading operation of the conventional controller, and FIG. 13 illustrates a reading operation of the multiple channel memory controller according to the embodiment of the present invention.

The multiple-access read request used in the simulation is a case in which four hosts request to read data of one block from the corresponding eMMC devices. The eMMC devices are configured to operate in the HS400 mode and the 8 bit data width condition.

As shown in FIG. 12, the conventional controller transfers a next read command to the eMMC devices after completing the reading operation of one block. At the same time, the DMAC transfers data of one block stored in the FIFO (32 bit data width) to a storage device (the AXI slave) of the host. That is, since one eMMC reading operation is completely ended and then the next eMMC reading operation is performed, a lot of break cycles of the DMAC are generated in the middle.

In contrast, as shown in FIG. 13, since the inventive controller has four FIFOs (8 bit width) and each channel has its own FIFO differently from the conventional eMMC controller, when a normal response is received thereto after a read command being transferred, the inventive controller may transfer the read command immediately to another eMMC device without waiting for data.

The DMAC, when the read data of one block is stored in the FIFO, transfers it to the storage device of the host. That is, when the next command uses a virtual channel that is not currently used even before one eMMC reading operation is completed, the next read command may be transferred, thereby minimizing break cycles.

Hereinafter, performance comparisons when there is a difference in data sizes in a write transfer process will be described. The processor 0 transfers data of 16 blocks and then additionally transfers data of two blocks, and the remaining processors transfer data of two blocks.

FIG. 14 and FIG. 15 respectively illustrate a difference between an operation of a conventional controller in which all four physical channels are combined and operated and an operation of a controller according to an embodiment of the present invention that operates using virtual channels, when data is transferred. The eMMC devices operate in the HS400 mode and the 8 bit data bus condition. In the conventional controllers, as shown in FIG. 14, data is sequentially transferred in accordance with its priority order. In a case of 16 blocks transfer, a time gain is obtained in data transfer. In cases of 2 blocks transfer, since four channels are bundled, only a request of one processor (single processor) may be processed. In contrast, in a case of 16 blocks data having a large data size as shown in FIG. 15, the inventive controller transfers data using a virtual channel to which four eMMC devices are connected, and in the cases of 2 blocks data, the inventive controller transfers data using virtual channels to which two eMMC devices are respectively connected. As such, in the inventive controller, since the software may allocate an optimized channel with respect to small-sized data requests to transfer data, the inventive controller achieves performance improvement of 23.4% compared to the conventional controller to which four eMMC devices are always connected.

FIG. 16 and FIG. 17 illustrate performance comparison results when amounts of transfer data are different depending on processors. It is assumed that the processor 0 to the processor 3 respectively transfer data of 3, 4, 6, and 7 blocks.

FIG. 16 illustrates a result of processing requests of all processors in the channel of the conventional controller to which four eMMCs are connected.

For a data transfer of data sizes that are not quadruple of one block (512B), it can be seen that loss of data transfer cycles occurs.

FIG. 17 illustrates a state of transferring all requests to the virtual channel respectively connected to two eMMC devices through an operation of the inventive controller. Since two eMMC devices are bundled, it can be seen that there are fewer loss cycles than the conventional controller. Therefore, the inventive controller achieves a performance improvement of about 19% compared to the conventional controller by performing the optimized channel allocation.

It was confirmed that the eMMC controller according to the embodiment of the present invention has improved performance up to 24% compared to the conventional controller through the simulation in the situation of the multiple processors.

As described above, according to the multiple channel memory controller using the virtual channel of the embodiment of the present invention, it is possible to adaptively control the number of physical channels allocated to the virtual channel and generation of the virtual channel corresponding to a data transfer amount and the number of processor accesses, thereby supporting both bandwidth enhancement and response time reduction for multiple processors, and therefore, effectively responding to the request of each of accessed multiple processors.

The accompanying drawings and the detailed description of the invention are only illustrative and are used for the purpose of describing the present invention, but those skilled in the art will understand that various modifications and other equivalent embodiments of the present invention are possible. Consequently, the true technical protective scope of the present invention must be determined based on the technical spirit of the appended claims.

What is claimed is:

1. A multiple channel memory controller, comprising:
an application adaptor that communicates with a host, transfers a command or data received from the host to the outside, and sends a response associated with the transferred command or data to the host;
a plurality of memory adaptors that are respectively connected one-to-one to a plurality of memory devices to form respective physical channels; and
a virtual channel controller that is located between the application adaptor and the plurality of memory adaptors, generates at least one independent virtual channel to which at least one of a plurality of physical channels is allocated, and transfers the command or data to at least one physical channel allocated to the virtual channel,
wherein the virtual channel controller dynamically adjusts the number of virtual channels or the number of physical channels allocated to the virtual channel, based on a transfer condition of the data or the number of access processors requested by the host.

2. The multiple channel memory controller of claim 1, wherein
the virtual channel controller includes a table which configures the virtual channel,
a new virtual channel is added when it is created, and then an existing virtual channel is deleted when it is not necessary,
a virtual channel is activated when a request is assigned, operates independently until an operation corresponding to the request is completed,
a virtual channel is de-activated when the operation using the virtual channel is completed.

3. The multiple channel memory controller of claim 1, wherein
the virtual channel controller, when there is an access request of a single processor, generates a single virtual channel, and transfers the data to the corresponding physical channel through the generated virtual channel, and
N (N is an integer of one or more) physical channels are allocated to the single virtual channel according to a transfer condition of the requested data of the single processor.

4. The multiple channel memory controller of claim 3, wherein
when the transfer condition satisfies a predetermined condition, N sub-data obtained by dividing the data into N blocks(N≥2) are simultaneously transferred to corresponding N physical channels to drive a bandwidth-enhancement mode, and
when the transfer condition does not satisfy the predetermined condition, one physical channel is allocated to the single virtual channel, such that the data is transferred to the allocated one physical channel.

5. The multiple channel memory controller of claim 1, wherein
the virtual channel controller configures the virtual channel based on the transfer condition or the number of the access processors determined by the host, and analyzes a request of the host inputted thereto to change the virtual channel dynamically or set in a fixed manner, and
the host requests a configuration to dynamically change the virtual channel in consideration of a current system status.

6. The multiple channel memory controller of claim 4, wherein
the virtual channel controller, when there are access requests of multiple processors including a plurality of processors, independently generates one virtual channel per each processor, and drives a multiple process mode of simultaneously processing the requests of multiple processors through the generated virtual channels, respectively.

7. The multiple channel memory controller of claim 6, wherein
the multiple processor includes at least one first processor in which the transfer condition of the data satisfies the predetermined condition and at least one second processor in which the transfer condition of the data does not satisfy the predetermined condition, and
the virtual channel controller allocates N (N≥2) physical channels to a virtual channel generated corresponding to the first processor, and allocates one physical channel to a virtual channel generated corresponding to the second processor to simultaneously drive the bandwidth-enhancement mode and the multiple process mode.
